(19) United States
(12) Patent Application Publication
(10) Pub. No.: US 2003/0033357 A1
(43) Pub. Date: Feb. 13, 2003

(54) Client aware content selection and retrieval in a wireless portal system

(76) Inventors: Luu Tran, Santa Clara, CA (US); Jeff Blattman, San Jose, CA (US); Harry Sorensen, Littleton, CO (US); Mark Eades, San Jose, CA (US)

Correspondence Address: WAGNER, MURABITO & HAO LLP, Two North Market Street, Third Floor, San Jose, CA, 95113, US

(21) Appl. No.: 09/929,654

(22) Filed: Aug. 13, 2001

(51) Int. Cl. G06F 15/16

(52) U.S. Cl. 709/203; 709/217; 709/246

(57) ABSTRACT

A wireless portal system has a wireless server with a client aware content selection and retrieval method and system. The client aware content selection and retrieval system includes logic for identifying client wireless devices connecting to the wireless server by using particular characteristics of the client in presenting content selected in response to connection requests from the client to the server. In one embodiment of the invention, the client aware content selection system receives an indication of a client type and uses this information to automatically update an extensible presentation logic that allows the server to format content selected by the end-user. The presentation logic further allows the client to dynamically add-on client content information, which are not already pre-stored in the wireless server. Content selection in the present invention is user defined, but content delivery is defined by the presentation logic, which allows the user selected content to be delivered in a client aware manner based on the client type information. Client aware determinations are made involving information availability, selectedness and presentability for a specific client type.

### CROSS REFERENCE TO RELATED APPLICATION

This patent application is related to co-pending patent application Ser. No. ______, filed on ______, by Luu Tran et al., entitled “Client Aware Detection in a Wireless Portal System”, attorney docket No.: SUN-P6087. which is hereby incorporated herein by reference in its entirety.

### FIELD OF THE INVENTION

The present claimed invention relates generally to the field of wireless communication systems. More particularly, the present claimed invention relates to client aware content selection and retrieval in a client independent wireless environment.

### BACKGROUND ART

The Internet has become the dominant vehicle for data communications. And with the growth of Internet usage has come a corresponding growth in the usage of Internet devices, wireless devices and services.

The growing base of Internet users has become accustomed to readily accessing Internet-based services such e-mail, calendar or content at any time from any location. These services, however, have traditionally been accessible primarily through stationary PCs. However, demand is now building for easy access to these and other communication services for mobile devices.

As the demand for mobile and wireless devices increases, enterprises must rollout new communication capabilities beyond the reach of traditional wired devices, by extending the enterprise with extra-net applications, etc., to effectively and efficiently connect mobile employees with their home base. As the number of digital subscribers grows, traditional wireless providers must find applications suitable to the needs of these new mobile users.

However, service providers are not the only ones seeking applications to meet the growing service needs of wireless users. Traditional portal developers are also extending their traditional PC browser desk-top services to these new wireless markets.

With the growth of the wireless market comes a corresponding growth in wireless business opportunities, which in today's ever-growing markets means, there is a plethora of services available to customers of the enterprises that use these services. Many wireless service providers are now looking to add to basic core services by extending services such as e-mail, short messaging service notification, and other links to Internet Protocol (IP) based applications to drive additional business and revenues.

As the wireless market grows and Internet access becomes more mainstream and begins to move to new devices, wireless service providers are looking to develop highly leveraged Internet Protocol based applications on top of existing network infrastructure. To meet the growing demand for wireless client devices, enterprises need to provide access to any type of service from any type of device from anywhere and to provide content suitable for these devices without incurring substantial cost overhead.

The growth in wireless devices also means that traditional computer users who used to be tied to their desktop computers may now be mobile and would require remote access to network applications and services such as email. The mobility of wireless users presents a host of challenges to service providers who may have to provide traditional service to these new wireless devices. One such service is provided by Sun Microsystems, Inc., through its iPlanet™ platform to allow service providers to grow their services from basic traditional services such as voice to leading edge wireless applications with carrier-grade reliability and performance.

In addition to the traditional network applications that these new wireless users seek, the growth of the Internet and the introduction of new Internet enabled wireless devices have led to the explosive use of community-based web sites or portals. This growth in portals has created a need for wireless environments to provide portal support to handle the collection of data related to different topics such as news, stock quotes, applications and services required by wireless device users.

FIG. 1 depicts a prior art wireless client dependent based environment solution to handle similarly configured wireless client running similar applications or portals. The environment depicted in FIG. 1 includes wireless devices such as a Wireless Applications Protocol (WAP) phone 101, a wireless PC 102, a refrigerator 103, etc. In general, the wireless environment depicted in FIG. 1 is categorized into the network (Internet 104), Clients (e.g. mobile phone 101, PCs 102 and household appliances 103) and resources (e.g., web-sites 105, portals 106 and other applications 107).

For most of the wireless clients connected to the Internet 104, portals 106 offer the client the starting point of experiencing the Internet 104. Portals 106 are typically community-based web-sites that securely hold a collection of data related to different topics, including such applications as news, stock quotes, etc. For example, a wireless client connecting to the Internet will first login to a web portal site (e.g., yahoo) and from there browse through various sites to search for a host of different services.

The portals typically reside in a portal server which bundles an aggregation of services provided by an Internet service provider and provides these services to wireless clients. A wireless portal server such as that developed by Sun Microsystems, Inc. provides such portal access to wireless application resources residing on resource servers A 108, B 109 and C 110.

The prior art wireless server depicted in FIG. 1 primarily supports the two major types of browsers known by most Internet users. These include the Microsoft Internet Browser and the Netscape Communicator Browser. These browsers are both HyperText Markup Language (HTML) based and suitable for some wireless devices, especially devices with large display screens. However, as wireless display screens get smaller in size, traditional HTML browsers are no longer suitable for transmitting content to these wireless devices.

To ensure suitable content delivery, wireless device and wireless software providers have developed a myriad of micro-browsers that appropriately adapt to these wireless devices with different display screen requirements in order to take advantage of the numerous contents on the Internet. The availability of these new micro-browsers means that service providers do not have to create different sets of content for different wireless devices even if the devices are dissimilar.

In the prior art system depicted in FIG. 1, content delivery is primarily performed in HTML over HTTP. This content is suitable for devices with wider screen displays such as desktop or wireless PCs. Due to the large screen displays these prior art systems have, a resource server does not have to format content prior to delivery to these devices.

Furthermore, in the prior art system depicted in FIG. 1, the wireless server always assumes content selected by the user and is therefore presentable. This means that the end-user has no means of customizing content delivered to their particular device.

However, wireless devices such as phones or other hand-held devices do not have the benefit of wider display screens and consequently content suitable to a desktop PC is not suitable for delivery to wireless devices without reformatting. Due to current bandwidth limitations in current wireless networks, transmitting content over protocols such HTTP results in rather poor performance of the devices receiving such content.

Transmitting HTML content to a wireless device with a micro-browser therefore presents a challenge to the display as well as to the user who has to scroll through pages of text in order to read content delivered to the wireless device. Additionally, the format of the data might not be particularly pleasing to the eye.

Another drawback of the prior art system such as that depicted in FIG. 1 is the use of predefined content, which a class of wireless clients may access. Predefining content to grant access to wireless clients restricts the ability and flexibility of the wireless server to dynamically add new clients during client run-time and server up time. Also, if content is predefined for a particular client, it is difficult to adapt the content to suit another client within the same class of devices, but with different content requirement characteristics.

Thus, for the prior art server to support the various types of wireless clients that service providers support, a systems administrator has to painstakingly manually add client specific content to support each wireless client if and when the client attempts to access the server.

As the number of models of wireless clients increase, having restricted content and very limited information about client characteristics impairs the ability of service providers to take advantage of new wireless technologies and provide efficient and cost effective services. This also impairs the ability of the wireless client to enjoy the full richness and look and feel of user interfaces provided by the server.

### SUMMARY OF INVENTION

Accordingly, to take advantage of the myriad of wireless applications and the numerous wireless clients being developed, a wireless server with extensibility capabilities to allow content delivery to wireless clients to be dynamically configured based on client type and formatted by the wireless server is needed. A need exists for “out-of-the-box” wireless client aware system solutions to allow technically unsophisticated end-users to connect to the wireless environment without unduly tasking the end-user's technical abilities. A need further exists for an improved and less costly device independent system, which improves efficiency and provides content to various wireless clients of different configurations without losing the embedded features designed for these devices.

Embodiments of the present invention are directed to a system and a method for wireless client aware content selection and presentation in a wireless network environment. In general, embodiments of the present invention vary the degree of providing content to a wireless client connecting to the wireless environment by implementing client aware content selection and presentation to retrieve content based on detailed client type information. In other words, the invention provides client specific content selection and retrieval in a wireless network environment. The invention is suitably adapted to function in a wireless portal environment.

Embodiments of the invention include an extensible content provider to dynamically allow client aware content additions to existing predefined content in the wireless server. The content provider further utilizes information created in a portal session based on the client type information provided by a client connecting to the wireless network to retrieve client specific content from back-end services connected to the wireless server.

In one embodiment of the present invention the content provider includes presentation logic which generates Wireless Markup Language (WML) decks and other wireless adaptable languages content based on the method invoked to provide content to a requesting client. The presentation logic generates the correct WML that is appropriate for the type of Wireless Application Protocol device requesting information based on pre-existing knowledge of the supported device type.

In another embodiment of the present invention, the presentation logic is responsible for encapsulating or formatting the back-end server content into appropriate markup language for delivery to the wireless clients. Service applications in the wireless server of the present invention know which presentation method to invoke based on information embedded in the User Agent contained in the HTPP header from a client request.

Embodiments of the present invention further include client content selection logic that allows the service provider to pre-determine the type of content that is made available to a particular client. Content selection is based on the type of client device, the type of services offered by the service provider and whether the client is a casual user or an advanced user of the services provided by the content service provider. An Application Programmable Interface can be used to collect extensible data sets that include custom client parameters for automatically identifying content of a particular client or class of clients.

Embodiments of the present invention further include content availability logic that is capable of being dynamically configured to provide content to clients connecting to the wireless server. In the present invention, the service provider can remotely control the availability logic in order to dynamically make content available to the client depending on the client type and the pre-arranged agreements between the end-user and the service provider.

In one embodiment, automatic client detection logic identifies the type or class of the client and stores this information into a client session data structure. The client session information can then be used by the content selection system to automatically access the most pertinent content data for the client using an intelligent file retrieval system. Client identification or class information can be used in automatically determining whether content desired by the client is available, selectable and presentable to the client. The content selection system receives an indication of a client type and uses this information to automatically construct content available for the client.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrates embodiments of the invention and, together with the description, serve to explain the principles of the invention:

Prior Art FIG. 1 is a block diagram of a conventional device dependent wireless system;

FIG. 2 is a block diagram of an implementation of a device independent wireless system of an embodiment of the present invention;

FIG. 3 is a block diagram of an exemplary internal architecture of the wireless server of FIG. 2;

FIG. 4 is a block diagram of an embodiment of an internal architecture of a service provider and profile service of an embodiment of the present invention; and

FIG. 5 is an exemplary depiction of one embodiment of the presentation logic of FIG. 4; and

FIG. 6 is an exemplary Venn diagram depiction of the selection, availability and presentation of content in an embodiment of the present invention.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments.

On the contrary, the invention is intended to cover alternatives, modifications and equivalents, which may be included within the spirit and scope of the invention as defined by the appended Claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

The invention is directed to a system, an architecture, subsystem and method to manage wireless client content selection in a client independent wireless environment in a way superior to the prior art. In accordance with an aspect of the invention, a wireless server provides wireless client aware content selection and presentation which enables client characteristics of devices to be used in determining the type of content to present by the wireless server.

In the following detailed description of the present invention, a system and method for a wireless Internet protocol based communication system are described. Numerous specific details are set forth in order to provide a thorough understanding of the present invention. However, it will be recognized by one skilled in the art that the present invention may be practiced without these specific details or with equivalents thereof.

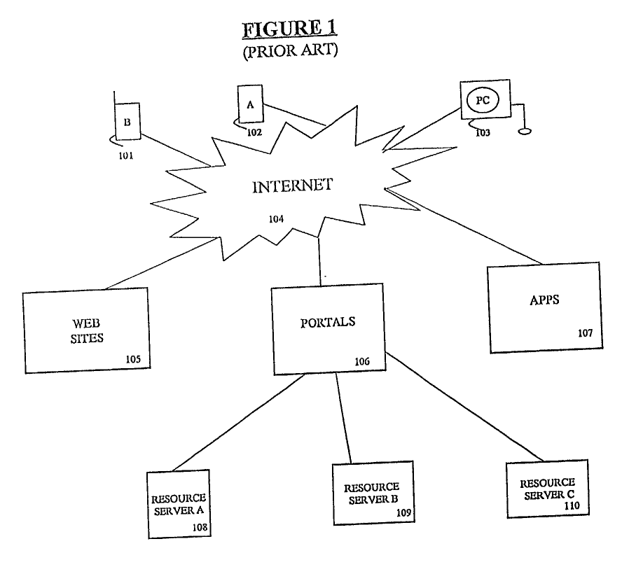

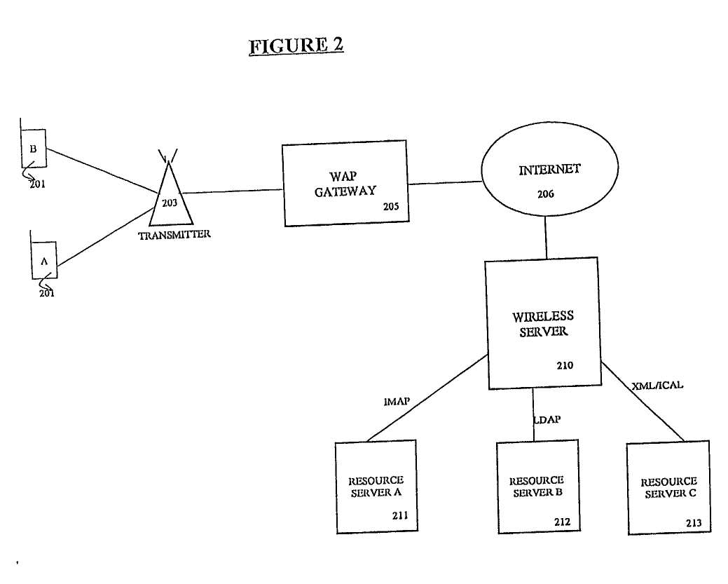

Generally, an aspect of the invention encompasses providing an integrated wireless Internet server which provides a wide range of voice, data, video and other services to wireless clients which may connect to the wireless environment to be serviced alongside predefined wireless clients. The invention can be more fully described with reference to FIGS. 2 through 6.

FIG. 2 depicts a wireless device independent based environment of the present invention. The wireless environment depicted in FIG. 2 comprises a wireless application protocol (WAP) based phone 201, a WAP transmission infrastructure 203, a WAP gateway 205, the Internet 206 and a wireless server 210. The WAP gateway 205 typically resides on the Local area network (LAN) within a telecom carrier premise. It is generally not a part of the wireless server 210. The WAP gateway 205 is responsible for converting the Wireless Markup Language (WML)/Hyper Text Transport Protocol (HTTP) content and protocol into a binary compressed, encoded, encrypted version of WML over WAP.

Conversely, the WAP gateway 205 also performs the translation of WAP commands into HTTP requests that can be sent over the public Internet 206. For example, in a GSM network, when a phone transmission is received by the mobile switching center, the gateway 205 distinguishes the transmission as a packet data and sends it to the proper channel to be processed. The WAP gateway 205 decompresses and decrypts the packets, as well as several other functions and formats the data into an HTTP request that is sent to the wireless server 210. The WAP gateway 205 can also store user's bookmarks, two of which could point to the wireless server's messaging and other resource services. The wireless server 210 communicates Wireless Markup Language (WML) over HTTP on the front-end and communicates in native protocol of the target server on the back-end.

The wireless server communicates to these back-end resources servers using the back-end server's native protocol. For example, the wireless server may communicate to resource server A 211 which may be a messaging server using IMAP. Lightweight Directory Access Protocol (LDAP) is used for all communications to and from the resource server B 212. And an Extensible Markup Language (XML) protocol may be used to communicate with resource server C 213.

Although the wireless server depicted in FIG. 2 is capable of communicating in these native protocols shown in FIG. 2, the wireless server's 210 protocol handling capability can be extended to support a variety of other protocols. The wireless server implements the WML interface and generates the corresponding WML content based on what it receives from the back-end server. The wireless server 210 also processes incoming HTTP requests in which a wireless device sending data or a request to the back-end servers. The wireless environment depicted in FIG. 2 typically supports wireless devices of dissimilar configuration and is thus device independent.

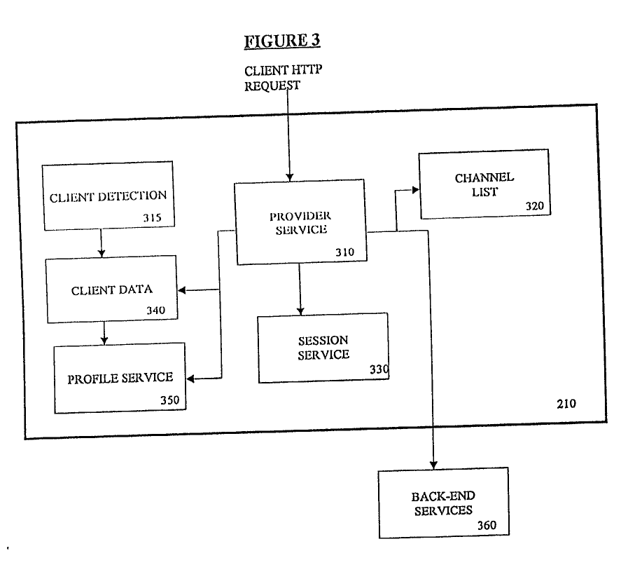

FIG. 3 is a block diagram illustration of one embodiment of the wireless server of the present invention. Wireless Server 210 (WS) comprises, Content Provider Service module 310, Client Detection module 315, Channel List 320, Session Service (SS) module 330, Client Data module 340 and Profile Service (PS) module 350. The server 210 also couples to back-end service 360 to retrieve content requested by the wireless clients connecting to the server 210.

The wireless server depicted in FIG. 3 is a flexible, scalable, extensible and capable of supporting a rich evolving range of networks such as Global System for Mobile communication (GSM) Networks, Code Division Multiple Access (CDMA) Networks, Time Division Multiple Access (TDMA) Networks, Third Generation (3G) Networks and others.

The architecture of the server is also capable of handling a variety of wireless environments and markup languages such as the wireless markup language (WML), the compact hypertext markup language (cHTML) and the hypertext markup language (HTML). The server is capable of providing support for multiple devices and is easily adaptable and extensible to additional devices and markup languages.

Still referring to FIG. 3, Provider Service module 310 is coupled to present a user's homepage and navigation links to other providers in the server 210. Provider Service 310 presents interfaces to the user to allow selection and ordering/positioning of channels on the user's home page. Provider Service 310 includes logic such as desktop providers, layout providers, configuration providers, etc., to format and present client specific content to the end-user based on client-type data which is identified by Client Detection module 315 and stored in Client Data module 340. Provider Service 310 uses software Application Protocol Interface (APIs) to retrieve a stored client type key, which is provided by the Client Detection module 315, as an index to retrieve appropriate client data. The Function of Client Detection Module 315 is described in the co-pending U.S. patent application entitled “CLIENT AWARE DETECTION IN A WIRELESS PORTAL SYSTEM”, filed on even date, Ser. No.: ______, assigned to the assignee of the present invention and hereby incorporated herein by reference.

Provider Service 310 uses the Client Data 340 to access a file path property in the server 210 to retrieve appropriate device specific templates. In the present invention, client data objects are extensible to allow additional properties to be added as needed for use by Provider Service 310. Provider Service 310 also uses a profile software API to store and retrieve provider specific properties in profile service 350.

Channel List 320 is coupled to Provider Service 310 to provide methods to store and retrieve multiple lists of selectable and available channels for the clients. In one embodiment of the present invention, Channel List 320 provides separate available and selectable lists for each client in a client aware manner. This allows users of these clients to independently configure what channels are displayed on their separate devices.

The present invention provides methods to display specific content in the form of channels. On an HTML device, these channels appear as table cells and on WML devices the channels appear as links to WML cards containing the contents of the channel.

Referring still to FIG. 3, profile service 350 is coupled to Client Data 340 and Provider 310 to provide selection and availability methods to Provider 310 using the client-type information stored in the Client Data 340.

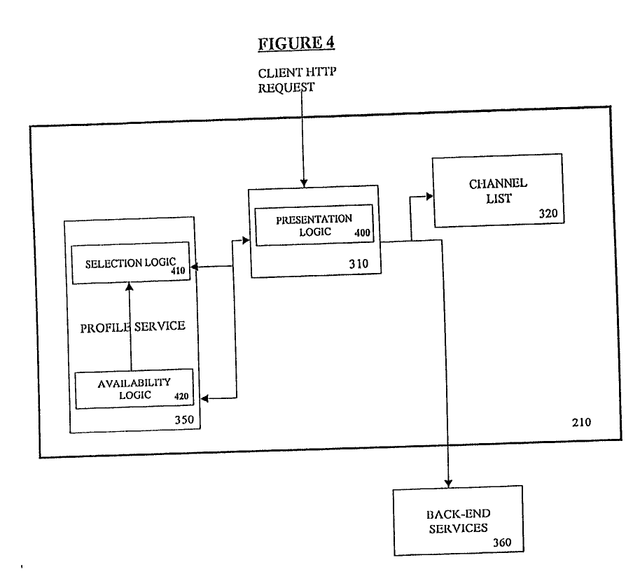

FIG. 4 is an exemplary block diagram illustration of one embodiment of the internal structure of the Provider Service 310 and the Profile Service 350 of the present invention. As depicted in FIG. 4, Provider Service 310 includes a Presentation Service 400. Presentation Service 400 formats content provided by various providers in Provider Service 310 in a suitable form for delivery to clients connecting to the server 210. The Presentation Service 400 accommodates a wide range of wireless devices and presents an optimized user interface to the wireless device, which is important in supporting a variety of WAP devices that have their own unique interfaces.

Profile Service 350 includes Selection Logic 410 and Availability Logic 420. In the present invention, unlike the prior art, content is never presumed to be automatically available for presentation to a client. Thus, Selection Logic 410 enables the user to select channels from Channel List 320 that the user would like or has the authorization to access on their device.

In the present invention content selection is not only a function of the user and the service to be selected, but also a function of the client type which the user is using to select content. For example, a user who may have pre-selected content suitable for display for a mobile device computer system which is stored in the wireless server 210, may not be able to display the same content in a phone device.

Thus, the selection logic 410 has the ability to identify the client type that a particular user is using to select previously selected content in the server 210. Client type information is provided by Client Detection 315 and with the user's ability to control selection logic 410, the present invention is able to provide the user with content selected by the user from any client.

Availability logic 420 is coupled to selection logic 410 to signal to the selection logic 410 whether content selected by the user is available not only to the user, but also to the device being used by the user. The service provider, who depending on the service being provided, is able to determine whether a particular user has the required authorization to access a particular content, typically controls availability logic 420. For example, if the service provider has paying and non-paying subscription to a particular content, users who have not subscribed to the content or have not paid the appropriate fee will not be able to have that content delivered to their devices.

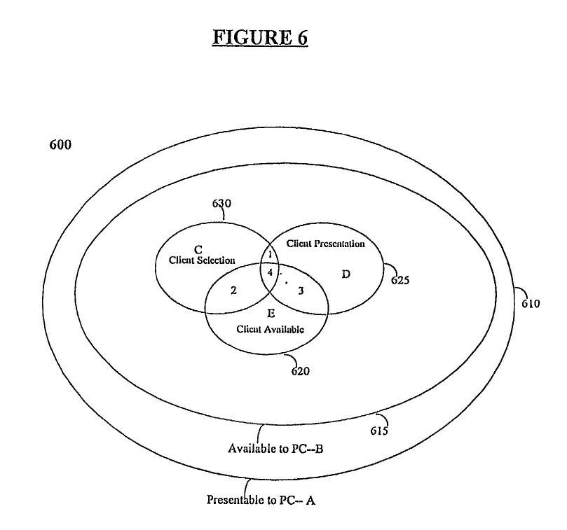

Thus, as depicted in FIG. 6, for content to be delivered to the end-user, the user may not only select the content, but the content must also be available to the user and suitable for presentation to the particular device before such content may be delivered.

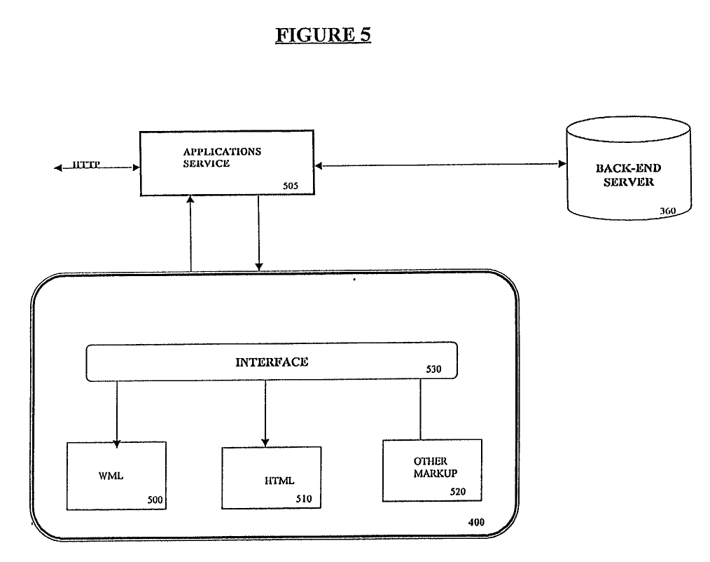

FIG. 5 is a functional block diagram illustration of one embodiment of the Presentation Service of the present invention. As depicted in FIG. 5, Presentation Service 400 comprises methods WML 500, HTML 510 and Other Markup Language 520 and Interface 530. Presentation Service 400 is the main interface between the Internet and the back-end service.

When a user initiates a session with the wireless server 210, Presentation Service 400 handles the initial request and parses the HTTP header for the User Agent (UA). Embedded in the UA is information that specifies the device type. If the UA indicates that the device is a WAP phone, the appropriate identifier is stored in the session 330. Based on the stored identifier, the presentation service 400 knows which methods to invoke in response to the client's request. When the back-end server responds to a user request, the service handling that response presents the information to the presentation service 400 for formatting. The presentation service 400 generates the optimized WML and sends it as a string back to the service module after which it is sent to the client over the Internet.

For example, the Presentation Service 400 consists of a set of classes or objects that implement various methods in a markup language interface. For example, the presentation service 400 may consist of an object class for WML 500, HTML 510 for a Nokia phone and an Ericsson phone respectively. Since the provider service 310 knows which markup language to use, provider service 310 invokes the appropriate methods in the presentation service 400 to deliver the appropriate content to the client. This functionality is performed based on the detected client type and therefore is “client aware.”

Because Presentation Service 400 consists of a set of classes and methods that understand the user interface of the client, the present invention is able to extend Presentation Service 400 to include additional clients. For example, if the developer wished to support a new phone that had a wide screen, the wireless service provider could create new templates of the existing WML class with newly implemented methods or over-ridden methods of the parent class. The new class would then understand that the client has a wider screen and would deliver the WML content to the phone in longer strings.

Having an extensible content system enables the wireless service provider to add or delete unique client identifying characteristics “on-the-fly” on top of predefined content stored in the server in order to offer access to categorized classes of clients or a client. Having an extensible content selection system also means that wireless service providers can perform simple code additions to the provider service rather than a more expensive way of entirely upgrading the wireless server each time the wireless service provider wants to change the predefined client type parameters of the services they provide.

FIG. 6 is a Venn diagram 600 depiction of one embodiment of the different states of content selection that are resolved using Profile Service 350 of the present invention. Content may be “selected”, “available,” and “presentable.” Content that is selected by a user means that the user has chosen to access the information. Content is presentable to a client when that client has hardware capabilities to display or otherwise render the information to a user. Content is available when the user has authorization to access the information. In order for content to be supplied to a client from the server, it must be available, presentable and also selected by the user.

The Profile Service 350 maintains, for each client type, a definition of content that can be presented by these Venn diagrams. In other words, for each client type, the Profile Service 350 maintains definitions for the available, presentable and selectable information. Two examples are shown in FIG. 6; one for a PC type client and another for a wireless type client.

As depicted in FIG. 6, some content that is presentable 610 and also available 615 to a desktop PC may also be available 620 to a wireless client connecting to the wireless server 210. In the embodiment depicted in FIG. 6, the content provided by the wireless server to the wireless client is a subset of the content available to the desktop PC. Wireless content that is selected by the wireless client is depicted by 630, content that is available to the wireless client is depicted by 620 and content that is presentable to the wireless client is depicted by 625.

The various combinations of states in which content may be provided to the wireless clients by the server are depicted by states 1 through 4. In one embodiment of the present invention, the optimum state for the delivery of content is state 4 in which the wireless client has the authorization to select available content and further the selected content is formatted to suit the display capabilities of the client. In state 2, for example, the content selected by the client is available, but is not presentable to the client's display hardware, e.g., screen is too small, not color, etc. The information will not be delivered. In state 3, the content is available, and is formatted for the client's presentation capabilities, but because the client does not have authorization to receive the information, it will not be sent.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the Claims appended hereto and their equivalents.

1. A wireless server system comprising:
an applications content selection module for providing wireless applications content parameters pertinent to a type of wireless client; and
a plurality of applications content provider service, in response to receiving a particular client type associated with a particular wireless client for dynamically presenting authorized content in a format suitable to said wireless client based on said particular client type, and
wherein said plurality of application content provider service is also for formatting selected content to said particular wireless client for presentation thereto.

2. The wireless server system of claim 1, further comprising an applications content available module coupled to said content selection module for determining whether content selected by said particular wireless client is available to the server system for delivery to said particular wireless client.

3. The wireless server system of claim 1, further comprises an automatic client detection service for automatically detecting and providing client type information of said particular wireless client.

4. The wireless server system of claim 3, wherein said particular client provides a service request to determine the type of content to be delivered to said particular client.

5. The wireless server system of claim 4, wherein said service request includes header information, which identifies the class type of, said particular client.

6. The wireless server system of claim 3, wherein said content is provided in response to said particular client if said content is authorized for delivery to said particular client and available to the server system.

7. The wireless server system of claim 6, wherein said applications content provider module formats content specific to client type information provided by said particular client.

8. The wireless server system of claim 7, wherein said particular client is a hand-held device.

9. The wireless server system of claim 8, wherein said particular client is a wireless phone.

10. A client aware applications content selection and retrieval system in a wireless network, comprising:
a wireless server;
a plurality of classes of wireless clients, each of said classes of wireless clients comprising unique identification parameters; and
a client aware content selection service for providing content selection and retrieval procedures in response to client type identifications of content accesses requests from said wireless clients.

11. The client aware content selection and retrieval system of claim 10, further comprising a content provider module coupled to said content selection service for delivering content selected by said wireless client in a format suitable for said wireless client.

12. The client aware content selection system of claim 11, wherein the content provider module includes a plurality of content provider logic for formatting content specific to a wireless client type.

13. The client aware content selection system of claim 12, wherein said content provider module is extensible to dynamically format client specific content during said client run-time.

14. The client aware content selection system of claim 11, further comprising a content availability module coupled to said selection module to determine a content specific request from said wireless client is available to said server system for delivery to said wireless client.

15. The client aware content selection system of claim 14, wherein said content is provided in response to said particular client if said content is authorized to said particular client and is available to said particular client.

16. A wireless server, comprising:
a client content provider service for providing information to a client in a client aware fashion based on selectedness, presentability and availability for each respective client type; and
a profile service logic for storing client profile information for said clients accessing said wireless server.

17. The wireless server of claim 16, wherein said client content provider comprises a plurality of content provider logic for presenting content suitably formatted for said client.

18. The wireless server of claim 17, wherein content provider further comprises content presentation service for formatting and presenting content suitable for display in a client aware manner.

19. The wireless server of claim 18, wherein said content presentation service comprises a user interface for supporting a variety of wireless devices connecting to said wireless server.

20. The wireless server of claim 19, wherein said user interface includes a wireless markup language interface.

21. The wireless server of claim 20, wherein said user interface further includes a wireless handheld markup language.

22. The wireless server of claim 18, wherein said content presentation service is extensible to dynamically include run-time content parameters unique to said client.

23. The wireless server of claim 16, wherein said profile service comprises selection logic for selecting content pertinent and uniquely identifiable to said client.

24. The wireless server of claim 16, wherein said profile service further comprise availability logic for determining whether content selected by said client is available for presentation to said client.
